(19) United States
(12) Patent Application Publication
(10) Pub. No.: US 2010/0050021 A1
(43) Pub. Date: Feb. 25, 2010

(54) ERROR CODE HANDLING IN A STORAGE SUBSYSTEM

(75) Inventors: John L. Neemidge, Round Rock, TX (US); Nishant B. Shah, Austin, TX (US); Stephen M. Tee, Marble Falls, TX (US); George L. White, Austin, TX (US)

Correspondence Address: IBM Corp. (AUS/RCR);c/o The Rolnik Law Firm, P.C., 24 N. Main St., Kingwood, TX, 77339, US

(73) Assignee: INTERNATIONAL BUSINESS MACHINES CORPORATION, Armonk, NY (US)

(21) Appl. No.: 12/197,678

(22) Filed: Aug. 25, 2008

(51) Int. Cl. G06F 11/07

(52) U.S. Cl. 714/42; 714/E11.026

(57) ABSTRACT

Disclosed is a computer implemented method and apparatus for making ownership changes to a storage subsystem. The host sends the first ownership change command to the storage subsystem then determines whether the storage subsystem responded with an error message. Upon responding to a determination that the storage subsystem responded with the error message, the host determines whether the storage subsystem indicated an error associated with an ownership change. In response to a determination that the storage subsystem indicated an error associated with an ownership change, the host sends a discover ownership message to the storage subsystem. Upon receiving a list of logical unit number associations from the storage subsystem, the host responds to receiving a list of logical unit number associations. The host performs a second ownership command to determine whether the list of logical unit number associations matches an ownership defined in the ownership change command. The host responds to a determination that the list of logical unit number associations matches an ownership defined in the ownership change command by aborting ownership changes.

### BACKGROUND OF THE INVENTION

1. Field of the Invention

The present invention relates generally to a computer implemented method, data processing system, and computer program product for stabilizing port addressing. More specifically, the present invention relates to responding to potential logical unit ownership errors.

2. Description of the Related Art

Architects of modern data processing systems have expanded storage capacity present in hard drives and other storage media. A recent innovation has been the ability to place multiple drives under the control of a common storage controller to form a storage subsystem. Storage subsystems provide an ability to form redundant disk arrays, as well as improve the ability to scale a system as a customer's data processing needs grow.

A storage subsystem is an assembly of at least two storage controllers and at least one logical unit or logical unit number (LUN) coupled to at least one of the storage controllers. A storage controller is a communication device that includes a processor and memory, as well as a port to a network. The network can be a fibre channel based network, or other forms of storage area networks (SAN). Fibre channel is a gigabit speed networking technology primarily used for SAN. Fibre channel may be in any form promulgated by the International Committee for Information Technology Standards (INCITS). Accordingly, the typical storage subsystem is robust in the sense that it can support a failure in one of its storage controllers and still provide speedy access to data of the various disk media.

One configuration of a storage subsystem is to arrange storage controllers as an active/passive array. Active/passive arrays allow I/O operations to take place over a primary storage controller. I/O or input/output is data transferred to or through a conductor or node. In this situation, the second storage controller is called a passive storage controller, while the primary storage controller carries I/O along an active path.

LUNs can be slow to respond to changes in ownership. This feature occurs, in part, because the LUN or its subsystem does not spontaneously provide unambiguous error messages that indicate a failure of an ownership change command. Rather, prior art data processing systems detected and responded to failed ownership changes by assuming the ownership change occurred, and then performing a disk access in normal operations. Such disk access and assumption could cause a failed ownership change to not be detected in a host nor acted on for an extended period that may range between 30 seconds and seven minutes.

### SUMMARY OF THE INVENTION

The present invention provides a computer implemented method and apparatus for making ownership changes to a storage subsystem. The host sends the first ownership change command to the storage subsystem then determines whether the storage subsystem responded with an error message. Responsive to a determination that the storage subsystem responded with the error message, the host determines whether the storage subsystem indicated an error associated with an ownership change. In response to a determination that the storage subsystem indicated an error associated with an ownership change, the host sends a discover ownership message to the storage subsystem. After receiving a list of logical unit number associations from the storage subsystem, the host responds to receiving a list of logical unit number associations. The host performs a second ownership command to determine whether the list of logical unit number associations matches an ownership defined in the ownership change command. The host responds to a determination that the list of logical unit number associations matches an ownership defined in the ownership change command by aborting ownership changes.

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 is a data processing system in accordance with an illustrative embodiment of the invention;

FIG. 2 is a storage area network that supports multiple hosts in accordance with an illustrative embodiment of the invention; and

FIG. 3 is a flowchart in accordance with an illustrative embodiment of the invention.

### DETAILED DESCRIPTION OF THE PREFERRED EMBODIMENT

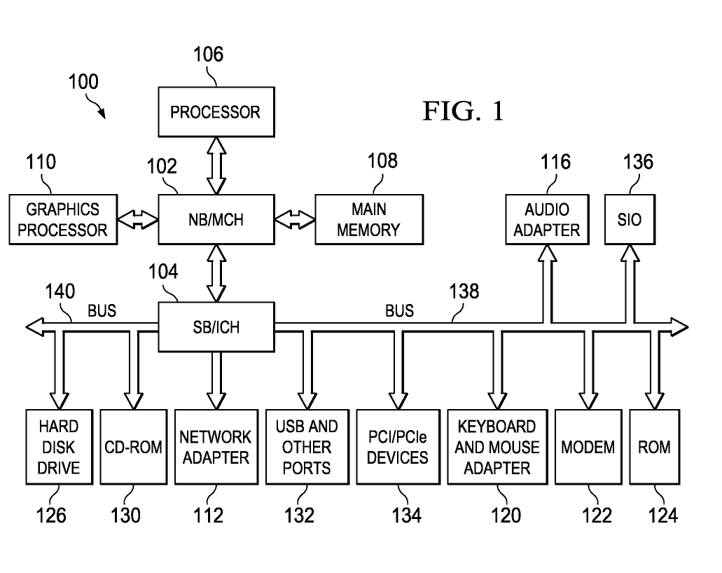

With reference now to the figures and in particular with reference to FIG. 1, a block diagram of a data processing system is shown in which aspects of an illustrative embodiment may be implemented. Data processing system 100 is an example of a computer, in which code or instructions implementing the processes of the present invention may be located. In the depicted example, data processing system 100 employs a hub architecture including a north bridge and memory controller hub (NB/MCH) 102 and a south bridge and input/output (I/O) controller hub (SB/ICH) 104. Processor 106, main memory 108, and graphics processor 110 connect to north bridge and memory controller hub 102. Graphics processor 110 may connect to the NB/MCH through an accelerated graphics port (AGP), for example.

In the depicted example, local area network (LAN) adapter 112 connects to south bridge and I/O controller hub 104 and audio adapter 116, keyboard and mouse adapter 120, modem 122, read only memory (ROM) 124, hard disk drive (HDD) 126, CD-ROM drive 130, universal serial bus (USB) ports and other communications ports 132, and PCI/PCIe devices 134 connect to south bridge and I/O controller hub 104 through bus 138 and bus 140. PCI/PCIe devices may include, for example, Ethernet adapters, add-in cards, and PC cards for notebook computers. PCI uses a card bus controller, while PCIe does not. ROM 124 may be, for example, a flash binary input/output system (BIOS). Hard disk drive 126 and CD-ROM drive 130 may use, for example, an integrated drive electronics (IDE) or serial advanced technology attachment (SATA) interface. A super I/O (SIO) device 136 may be connected to south bridge and I/O controller hub 104.

An operating system runs on processor 106 and coordinates and provides control of various components within data processing system 100 in FIG. 1. The operating system may be a commercially available operating system such as Microsoft® Windows® XP. Microsoft and Windows are trademarks of Microsoft Corporation in the United States, other countries, or both. An object oriented programming system, such as the Java™ programming system, may run in conjunction with the operating system and provides calls to the operating system from Java™ programs or applications executing on data processing system 100. Java™ is a trademark of Sun Microsystems, Inc. in the United States, other countries, or both.

Instructions for the operating system, the object-oriented programming system, and applications or programs are located on storage devices, such as hard disk drive 126, and may be loaded into main memory 108 for execution by processor 106. The processes of the present invention can be performed by processor 106 using computer implemented instructions, which may be located in a memory such as, for example, main memory 108, read only memory 124, or in one or more peripheral devices.

Those of ordinary skill in the art will appreciate that the hardware in FIG. 1 may vary depending on the implementation. Other internal hardware or peripheral devices, such as flash memory, equivalent non-volatile memory, and the like, may be used in addition to or in place of the hardware depicted in FIG. 1. In addition, the processes of the illustrative embodiments may be applied to a multiprocessor data processing system.

In some illustrative examples, data processing system 100 may be a personal digital assistant (PDA), which is configured with flash memory to provide non-volatile memory for storing operating system files and/or user-generated data. A bus system may be comprised of one or more buses, such as a system bus, an I/O bus and a PCI bus. Of course, the bus system may be implemented using any type of communications fabric or architecture that provides for a transfer of data between different components or devices attached to the fabric or architecture. A communication unit may include one or more devices used to transmit and receive data, such as a modem or a network adapter. A memory may be, for example, main memory 108 or a cache such as found in north bridge and memory controller hub 102. A processing unit may include one or more processors or CPUs. The depicted example in FIG. 1 is not meant to imply architectural limitations. For example, data processing system 100 also may be a tablet computer, laptop computer, or telephone device in addition to taking the form of a PDA.

The terminology used herein is for the purpose of describing particular embodiments only and is not intended to be limiting of the invention. As used herein, the singular forms “a”, “an”, and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

As will be appreciated by one skilled in the art, the present invention may be embodied as a system, method or computer program product. Accordingly, the present invention may take the form of an entirely hardware embodiment, an entirely software embodiment (including firmware, resident software, micro-code, etc.) or an embodiment combining software and hardware aspects that may all generally be referred to herein as a “circuit,” “module”, or “system.” Furthermore, the present invention may take the form of a computer program product embodied in any tangible medium of expression having computer usable program code embodied in the medium.

Any combination of one or more computer usable or computer readable medium(s) may be utilized. The computer-usable or computer-readable medium may be, for example but not limited to, an electronic, magnetic, optical, electromagnetic, infrared, or semiconductor system, apparatus, device, or propagation medium. More specific examples (a non-exhaustive list) of the computer-readable medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CDROM), an optical storage device, a transmission media such as those supporting the Internet or an intranet, or a magnetic storage device. Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory. In the context of this document, a computer-usable or computer-readable medium may be any medium that can contain, store, communicate, propagate, or transport the program for use by or in connection with the instruction execution system, apparatus, or device. The computer-usable medium may include a propagated data signal with the computer-usable program code embodied therewith, either in baseband or as part of a carrier wave. The computer usable program code may be transmitted using any appropriate medium, including but not limited to wireless, wireline, optical fiber cable, RF, etc.

Computer program code for carrying out operations of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

The present invention is described below with reference to flowchart illustrations and/or block diagrams of methods, apparatus, and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable medium that can direct a computer or other programmable data processing apparatus to function in a particular manner, such that the instructions stored in the computer-readable medium produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide processes for implementing the functions/acts specified in the flowchart and/or block diagram block or blocks.

The aspects of the illustrative embodiments provide a computer implemented method, data processing system, and computer program product for handling an ambiguous error message that is received in response to sending an ownership change command. Accordingly, if a true error in device ownership occurred, such an error may be detected rapidly. Alternatively, if an error unrelated to device ownership occurred, proper handling of the error may be performed.

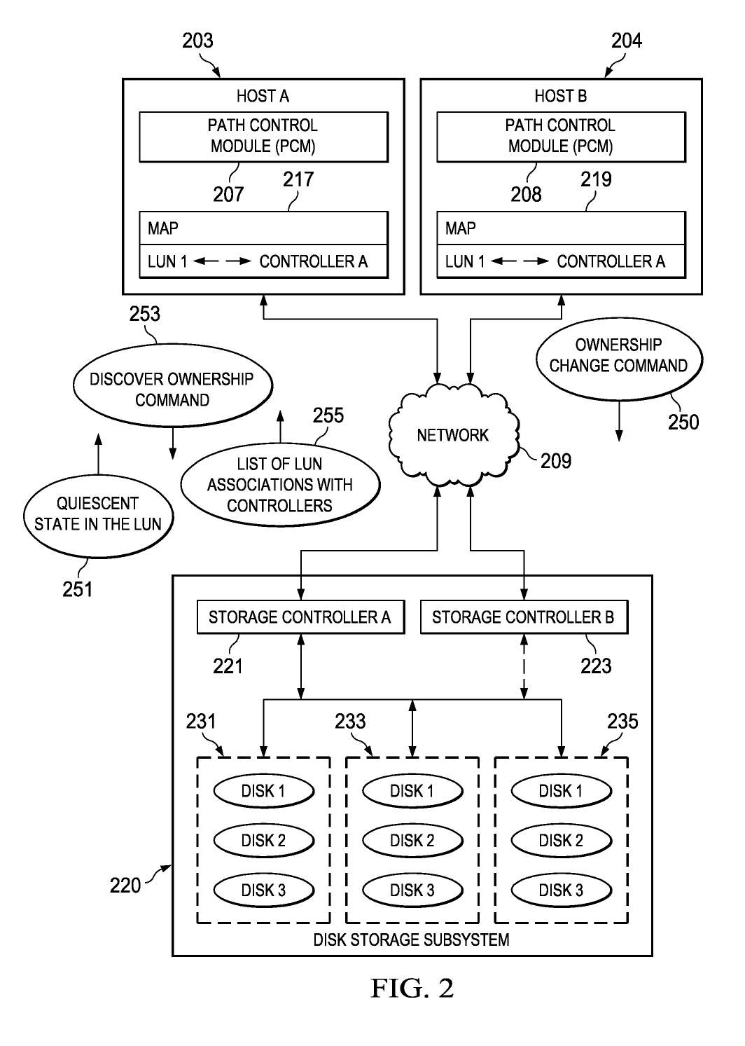

FIG. 2 is a storage area network that supports multiple hosts in accordance with an illustrative embodiment of the invention. Host A 203 and host B 204 are data processing systems. Each host may be, for example, an example of data processing system 100 of FIG. 1. A host is a data processing system that accesses a Storage Area Network (SAN). The storage subsystem may connect to the host via a host bus adapter. Within each host, support for the function of accessing storage is performed by the controller path control module (PCM). Thus, host A 203 relies on PCM 207, and host B 204 relies on PCM 208 to communicate with storage media. Accordingly, network 209 may provide a means to connect to a storage subsystem such as disk storage subsystem 220.

Disk storage subsystem 220 is accessed via storage controller A 221 and storage controller B 223. Storage controllers A and B are examples of storage controllers. As such, each storage controller is in one of two states with respect to a given logical unit number (LUN): active state or passive state. As depicted in FIG. 2, storage controller A 221 is active while storage controller B 223 is passive. Accordingly, host A 203 and host B 204 direct messages to storage controller A 221 for purposes of accessing media under the control of disk storage subsystem 220. Within the disk storage subsystem are arrays of disks.

One or more disks are organized into logical units. A logical unit or logical unit number (LUN) is one or more disk drives that are addressable as a unit and is presented to a host via one or more storage controllers. A logical unit may be addressable using protocols such as Small Computer System Interface (SCSI), Fibre Channel Protocol (FCP), HyperSCSI, among others, depending on the capabilities of the applicable storage controller. Consequently, disk storage subsystem 220 is comprised of LUN 1 231, LUN 2 233, and LUN 3 235.

Each controller regulates the arrival and departure of data to be written to, as well as read from, the LUNs. Such data can be I/O transferred to or through a conductor or node, and may be information or instructions that are compressed or uncompressed, corrupted or uncorrupted. I/O may be considered to be suspended if the signals are not passed in any form to a targeted device. A processor may buffer write operations during intervals that I/O is suspended to the target LUN of such write operations. Processors may have limited amounts of memory that can be used to buffer such operations. The storage controllers, storage controller A 221, and storage controller B 223 can be fibre channel controllers. A fibre channel controller is a storage controller configured to handle I/O transferred across a fibre channel.

Each host relies on a mapping table to direct the addressing of a PCM for storage operations. A mapping table is a data structure that establishes associations between a storage controller and one or more logical units. The mapping table is accessible to a host, and may be stored to memory or to local storage. Mapping table 217 is a table stored to memory of host A 203. A similar mapping table, mapping table 219, is present in host B 204. A mapping table depicts the association of LUN 1 231 with storage controller A 221.

In contrast, each storage controller has a list of logical unit number associations. A list of logical unit number associations is a list of one or more logical unit associations with one or more storage controllers. Such a list is formed at a disk storage subsystem, and can be transmitted to a host. The list of logical unit number associations can be a single association of a LUN to a storage controller.

Although FIG. 2 shows storage controller A 221 as the active storage controller, storage controller B 223 can become the active storage controller. Host A 203 and host B 204 can change the active storage controller to become storage controller B 223. Such a change can change the ownership of LUNs, such as LUN 1 231, LUN 2 233, and LUN 3 235 to be owned by storage controller B 223.

Messages that may be passed between a storage controller and a host include ownership change command 250, and error message indicating a quiescent state in the LUN 251, described further below. A host may respond to the error message with discover ownership command 253. A storage controller can further respond to the host with a list of LUN associations with controllers 255.

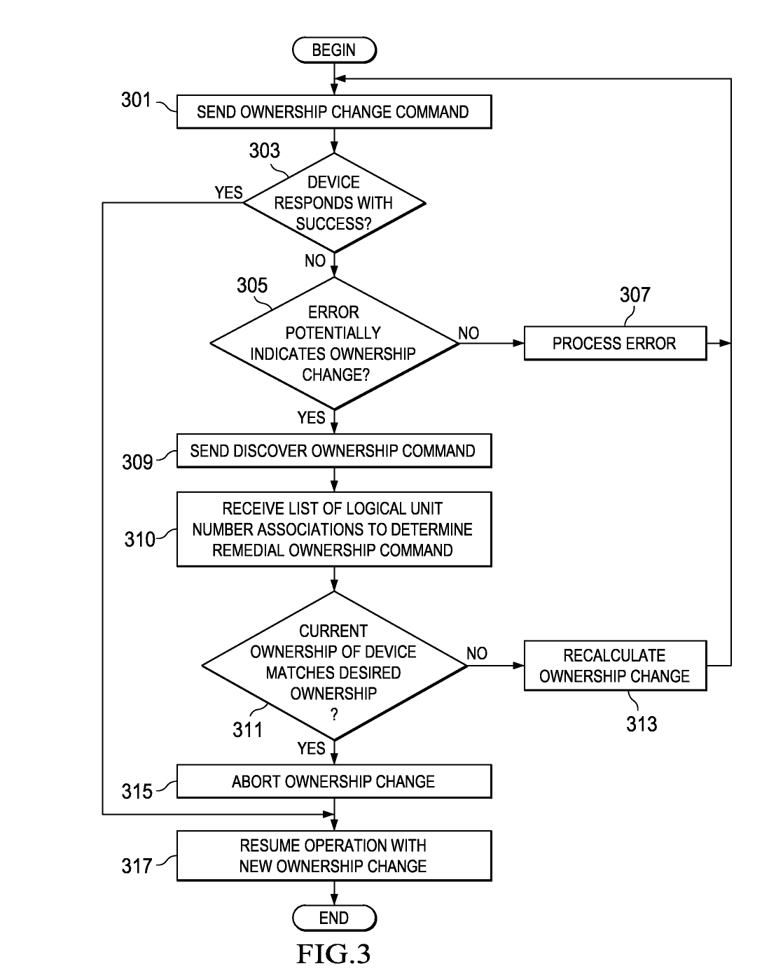

FIG. 3 is a flowchart in accordance with an illustrative embodiment of the invention. Initially, a host sends an ownership change command to a LUN (step 301). An ownership change command is a command of a host transmitted to a storage subsystem to indicate a change in ownership between the host and at least one logical unit of the storage subsystem. The ownership change command defines an association or ownership between a LUN and a path control module. The ownership change command can be, for example, a SCSI mode select command using a mode page 2C. The SCSI mode select command can include a list of affected LUNs and instructions concerning how each LUN is to change ownership, if at all. Accordingly, the ownership change command may define ownership changes from an existing set of associations or ownership between a LUN and a PCM. In addition, the ownership change command may define an ownership relationship between LUN and PCM that is consistent with a current state of the LUN and PCM. As such, the ownership change command may trigger changes in the LUN, PCM or both that bring about the exact same state as existed prior to the ownership change command. Thus, an ownership change can be one or more steps performed at the LUN in response to receiving the ownership change command.

Next, the host determines whether the device responds with success (step 303). A success response can be a SCSI message that lacks any error flags. If the host determines that the ownership change command completed successfully, the host may resume operation based on the ownership change (step 317). The operation to resume may be a normal read and/or write of I/O to the device. Processing may terminate thereafter. However, at step 303, the host may receive an error that can indicate a quiescent state in the LUN, for example “quiescent state in the LUN” 251 of FIG. 2. Such an error message may be a 0x8B02 transmitted in a responsive message from the LUN. Such an error message may indicate a mean the LUN is shutting down I/O.

In response to a negative outcome to step 303, the host may determine if the error potentially indicates an error change (step 305). If the LUN indicated an error other than the quiescent state, the host may make a negative determination at step 305. Accordingly, the host may process the error (step 307). The error may be processed as is known in the art, for example, 0x2900 storage controller was reset, 0x0401 unit processor becoming ready, and the like. The host may further process by again performing step 301 to send an ownership change command.

Alternatively, step 305 may be evaluated positively. The host may make a positive determination based on receiving an error associated with an ownership change. An error associated with an ownership change is an error that may be produced as a storage subsystem responds to an ownership change command and suffers from a fault, discontinuity or degradation caused by the ownership change. An error associated with an ownership change may also be associated with conditions other than an ownership change. An error associated with an ownership change, can be, for example, an error indicating that an associated logical unit is in a quiesced state.

Consequently, the host may send an ownership discovery command. An ownership change command is a command of a host transmitted to a storage subsystem to indicate a change in ownership between the host and at least one logical unit of the storage subsystem. The ownership change command defines an association between a LUN and a path control module. The ownership change command can be, for example, a SCSI mode sense command using a mode page 2C.

Following a positive determination at step 305, the host may send a discover ownership command (step 309). A discover ownership message is a query transmitted via the PCM to the storage subsystem to request a list of one or more hosts controlling the storage subsystem. The discover ownership command may be, for example, discover ownership command 253 of FIG. 2. Such a query can be, for example, a Small Computer System Interface (SCSI) check command or condition message having an autosense buffer containing 0x8B02. A Small Computer System Interface (SCSI) command is a set of standards for physically connecting and transferring data between computers and peripheral devices. The SCSI standards define commands, protocols, and electrical and optical interfaces. SCSI standards can include, for example, American National Standards Institute (ANSI) SCSI Standard, X3.131-1986, serial SCSI, Internet SCSI.

Next, the host may receive a list of logical unit number (LUN) associations from the storage subsystem (step 310). This step of receiving may be in direct response to transmitting a SCSI command to the storage subsystem, as described above. Responsive to receiving a list of LUN associations from the storage subsystem, the host may perform a remedial ownership command or second ownership change command. The remedial ownership command may include re-executing the step 301 to send an ownership change command.

Remedial ownership can include the host determining whether the current ownership of a device or LUN matches a desired ownership (step 311). The desired ownership can be the ownership as defined in a most recent execution of step 301. A positive determination at step 311 may cause the host to abort ownership change (step 315). The abort ownership change may comprise the host directing the PCM to update a PCM data structure to redirect I/O of a LUN to the PCM. The PCM data structure is a data structure maintained by the PCM. The PCM data structure may be, for example, mapping table 217, of FIG. 2. The host may continue by executing step 317.

However, a negative determination to step 311 may result in the host recalculating the ownership change (step 313). The host may calculate or recalculate LUN ownership by examining the PCM's LUN ownership information compared to the LUN ownership as described in the list of LUN associations with controllers 255, of FIG. 2. Differences determined in this manner make up a result to the calculation for a subsequent ownership change. Next, the host for at least a second time sends an ownership change command (step 301). This ownership change command is based on the calculations performed in step 313.

The illustrative embodiments permit a host to make confirmatory queries shortly after sending an ownership change command, rather than periodic verification of ownership of LUNs decoupled from the progenitor ownership change command.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The invention can take the form of an entirely hardware embodiment, an entirely software embodiment or an embodiment containing both hardware and software elements. In a preferred embodiment, the invention is implemented in software, which includes but is not limited to firmware, resident software, microcode, etc.

Furthermore, the invention can take the form of a computer program product accessible from a computer-usable or computer-readable medium providing program code for use by or in connection with a computer or any instruction execution system. For the purposes of this description, a computer-usable or computer readable medium can be any tangible apparatus that can contain, store, communicate, propagate, or transport the program for use by or in connection with the instruction execution system, apparatus, or device.

The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk-read only memory (CD-ROM), compact disk-read/write (CD-R/W) and DVD.

A data processing system suitable for storing and/or executing program code will include at least one processor coupled directly or indirectly to memory elements through a system bus. The memory elements can include local memory employed during actual execution of the program code, bulk storage, and cache memories, which provide temporary storage of at least some program code in order to reduce the number of times code must be retrieved from bulk storage during execution.

Input/output or I/O devices (including but not limited to keyboards, displays, pointing devices, etc.) can be coupled to the system either directly or through intervening I/O controllers.

Network adapters may also be coupled to the system to enable the data processing system to become coupled to other data processing systems or remote printers or storage devices through intervening private or public networks. Modems, cable modem and Ethernet cards are just a few of the currently available types of network adapters.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

What is claimed is:

1. A computer implemented method for making ownership changes to a storage subsystem, the method comprising:
sending a first ownership change command to the storage subsystem;
determining whether the storage subsystem responded with an error message;
responsive to a determination that the storage subsystem responded with the error message, determining whether the storage subsystem indicated an error associated with an ownership change;
responsive to a determination the storage subsystem indicated an error associated with an ownership change, sending a discover ownership message to the storage subsystem;
receiving a list of logical unit number associations from the storage subsystem;
responsive to receiving a list of logical unit number associations, performing a second ownership command;
determining whether the list of logical unit number associations matches an ownership defined in the ownership change command; and
responsive to a determination that the list of logical unit number associations matches an ownership defined in the ownership change command, aborting ownership changes.

2. The computer implemented method of claim 1, wherein the error associated with an ownership change is an error indicating that an associated logical unit is in a quiesced state.

3. The computer implemented method of claim 2, wherein the error associated with an ownership change is an SCSI error.

4. The computer implemented method of claim 1, wherein receiving further comprises:
transmitting a Small Computer System Interface (SCSI) command to the storage subsystem.

5. The computer implemented method of claim 4, wherein the storage subsystem is comprised of two or more fibre channel controllers.

6. The computer implemented method of claim 1, wherein performing the second ownership command further comprises:
determining whether the list of logical unit associations matches an ownership defined in the ownership change command; and
responsive to a determination that the list of logical unit associations matches an ownership defined in the ownership change command, aborting ownership changes.

7. The computer implemented method of claim 6, wherein aborting further comprises:
directing a path control module to update a path control module (PCM) data structure to redirect I/O of a logical unit number (LUN) to the path control module, wherein the first ownership change command associates the path control module with the logical unit number.

8. The computer implemented method of claim 1, wherein performing the second ownership command further comprise:
determining whether the list of logical unit associations fails to match an ownership defined in the ownership change command; and
responsive to a determination that the list of logical unit associations fails to match an ownership defined in the ownership change command, recalculating ownership change.

9. A computer program product for making ownership changes to a storage subsystem, the computer program product comprising: a computer usable medium having computer usable program code embodied therewith, the computer program product comprising:
computer usable program code configured to send a first ownership change command to the storage subsystem;
computer usable program code configured to determine whether the storage subsystem responded with an error message;
computer usable program code configured to determine whether the storage subsystem indicated an error associated with an ownership change, responsive to a determination that the storage subsystem responded with the error message;
computer usable program code configured to send a discover ownership message to the storage subsystem, responsive to a determination the storage subsystem indicated an error associated with an ownership change;
computer usable program code configured to receive a list of logical unit number associations from the storage subsystem;
computer usable program code configured to perform a second ownership command, responsive to receiving a list of logical unit number associations;
computer usable program code configured to determine whether the list of logical unit number associations matches an ownership defined in the ownership change command; and
computer usable program code configured to abort ownership changes, responsive to a determination that the list of logical unit number associations matches an ownership defined in the ownership change command.

10. The computer program product of claim 9, wherein the error associated with an ownership change is an error indicating that an associated logical unit is in a quiesced state.

11. The computer program product of claim 10, wherein the error associated with an ownership change is an SCSI error.

12. The computer program product of claim 9, wherein computer usable program code configured to receive further comprises:
computer usable program code configured to transmit a Small Computer System Interface (SCSI) command to the storage subsystem.

13. The computer program product of claim 12, wherein the storage subsystem is comprised of two or more fibre channel controllers.

14. The computer program product of claim 9, wherein computer usable program code configured to perform the second ownership command further comprises:
computer usable program code configured to determine whether the list of logical unit associations matches an ownership defined in the ownership change command; and
computer usable program code configured to abort ownership changes, responsive to a determination that the list of logical unit associations matches an ownership defined in the ownership change command.

15. The computer program product of claim 14, wherein computer usable program code configured to abort further comprises:
computer usable program code configured to direct a path control module to update a path control module (PCM) data structure to redirect I/O of a logical unit number (LUN) to the path control module, wherein the first ownership change command associates the path control module with the logical unit number.

16. The computer program product of claim 9, wherein computer usable program code configured to perform the second ownership command further comprise:
computer usable program code configured to determine whether the list of logical unit associations fails to match an ownership defined in the ownership change command; and
computer usable program code configured to recalculate ownership change, responsive to a determination that the list of logical unit associations fails to match an ownership defined in the ownership change command.

17. A data processing system comprising:
a bus;
a storage device connected to the bus, wherein computer usable code is located in the storage device;
a communication unit connected to the bus;
a processing unit connected to the bus, wherein the processing unit executes the computer usable code for making ownership changes to a storage subsystem, wherein the processing unit executes the computer usable program code to send a first ownership change command to the storage subsystem;
determine whether the storage subsystem responded with an error message;
determine whether the storage subsystem indicated an error associated with an ownership change, responsive to a determination that the storage subsystem responded with the error message;
send a discover ownership message to the storage subsystem, responsive to a determination the storage subsystem indicated an error associated with an ownership change;
receive a list of logical unit number associations from the storage subsystem;
perform a second ownership command, responsive to receiving a list of logical unit number associations;
determine whether the list of logical unit number associations matches an ownership defined in the ownership change command; and
abort ownership changes, responsive to a determination that the list of logical unit number associations matches an ownership defined in the ownership change command.

18. The data processing system claim 17, wherein the error associated with an ownership change is an error indicating that an associated logical unit is in a quiesced state.

19. The data processing system claim 18, wherein the error associated with an ownership change is an SCSI error.

20. The data processing system of claim 17, wherein in executing computer usable code to receive, the processor executes computer usable code to transmit a Small Computer System Interface (SCSI) command to the storage subsystem.

21. The data processing system claim 20, wherein the storage subsystem is comprised of two or more fibre channel controllers.

22. The data processing system claim 17, wherein in executing computer usable code to perform, the processor executes computer usable code to determine whether the list of logical unit associations matches an ownership defined in the ownership change command; and abort ownership changes, responsive to a determination that the list of logical unit associations matches an ownership defined in the ownership change command.

23. The data processing system claim 22, wherein in executing computer usable code to abort, the processor executes computer usable code to direct a path control module to update a path control module (PCM) data structure to redirect I/O of a logical unit number (LUN) to the path control module, wherein the first ownership change command associates the path control module with the logical unit number.

24. The data processing system claim 17, wherein in executing computer usable code to perform, the processor executes computer usable code to determine whether the list of logical unit associations fails to match an ownership defined in the ownership change command; and recalculate ownership change, responsive to a determination that the list of logical unit associations fails to match an ownership defined in the ownership change command.
